(19) United States
(12) Patent Application Publication
(10) Pub. No.: US 2018/0164156 A1
(43) Pub. Date: Jun. 14, 2018

(54) Hybrid Sensor with Enhanced Infrared Detection Capabilities

(71) Applicant: Microsoft Technology Licensing, LLC, Redmond, WA (US)

(72) Inventors: Raymond Kirk Price, Redmond, WA (US); Michael Bleyer, Seattle, WA (US); Jian Zhao, Kenmore, WA (US); Denis Claude Pierre Demandolx, Bellevue, WA (US)

(21) Appl. No.: 15/375,200

(22) Filed: Dec. 12, 2016

(51) Int. Cl. G01J 1/42; H04N 5/33; H04N 13/02

(52) U.S. Cl. CPC G01J 1/4228; H04N 2013/0081; H04N 13/0239; H04N 5/332

(57) ABSTRACT

A hybrid sensor is described herein that includes a plurality of photoreceptive element domains. Each domain includes: a first subset of infrared (IR) photoreceptive elements that are selectively receptive to infrared radiation; and a second subset of visible-spectrum photoreceptive elements that are selectively receptive to visible spectrum light. The number of IR photoreceptive elements in the first subset is equal to or greater than a number of visible-spectrum photoreceptive elements in the second subset. In one case, each domain includes a mix of visible-spectrum photoreceptive elements that conforms to a Bayer pattern, or to some other color filer array pattern. Different applications can incorporate the hybrid sensor, including, but not limited to, scene reconstruction applications, object recognition applications, biometric authentication applications, night vision applications, etc.

### BACKGROUND

Some devices combine infrared information and color information to achieve some effect. These devices may obtain the color information from a first CMOS sensor that includes photoreceptive elements that are selectively responsive to visible-spectrum electromagnetic radiation. These devices may obtain the infrared information from a second CMOS sensor that includes photoreceptive elements that are selectively responsive to infrared radiation.

However, the use of a separate infrared sensor and visible-spectrum sensor may lead to artifacts. Such problems are generally caused by the difficulty in precisely matching the IR information with the separately obtained color information. To counter these issues, the devices may resort to complex calibration and synchronization mechanisms. Nevertheless, artifacts can still occur.

To address the above issues, some devices use a hybrid sensor that includes both visible-spectrum photoreceptive elements and infrared photoreceptive elements. For instance, one design modifies a Bayer pattern by replacing one of the green photoreceptive elements with an infrared photoreceptive element, such that the hybrid sensor includes a domain that includes one red photoreceptive element, one green photoreceptive element, one infrared photoreceptive element, and one blue photoreceptive element.

### SUMMARY

A hybrid sensor is described herein that includes a plurality of photoreceptive element domains. Each domain includes: a first subset of infrared (IR) photoreceptive elements that are selectively receptive to infrared radiation; and a second subset of visible-spectrum photoreceptive elements that are selectively receptive to visible spectrum light. In one implementation, the number of IR photoreceptive elements in the first subset is equal to or greater than a number of visible-spectrum photoreceptive elements in the second subset. In other words, in one implementation, the percentage of IR photoreceptive elements is at least 50%.

In other implementations, the percentage of IR photoreceptive elements is even greater, such as, without limitation, at least 75%, or at least 80%, etc.

According to another illustrative aspect, each domain includes a mix of visible-spectrum photoreceptive elements that conforms to a Bayer pattern, or to some other color filter array pattern. With respect to the Bayer pattern, for instance, each domain includes an RGB mix that includes one red photoreceptive element, two green photoreceptive elements, one blue photoreceptive element, or some multiple of that RGB mix.

According to another illustrative aspect, a data collection component collects IR information from the IR photoreceptive elements of the hybrid sensor, and collects color information from the visible-spectrum photoreceptive elements of the hybrid sensor. By virtue of the characteristics described above, the IR information can capture an imaged scene with a resolution that is the equal to or greater than the color information.

According to another illustrative aspect, different applications can incorporate the hybrid sensor, including, but not limited to, scene reconstruction applications, object recognition applications, biometric authentication applications, night vision applications, and so on.

According to one technical merit among others, the hybrid sensor allows an application to construct a depth map (or some other processing result based on the infrared information) having particularly high resolution. For instance, a hybrid sensor which replaces one green photoreceptive element with an IR photoreceptive element has, overall, only 25% IR photoreceptive elements, whereas the hybrid sensor described herein has (in one implementation) at least 50% IR photoreceptive elements. According to another merit, the hybrid sensor allows an application to construct balanced color information, e.g., because it preserves the mix of color photoreceptive elements in a Bayer pattern (or some other standard pattern). For instance, a hybrid sensor which replaces one green photoreceptive element with an IR photoreceptive element has a reduced capability of detecting green light (which is the portion of the spectrum to which human eyes are most sensitive), whereas the hybrid sensor described herein can preserve the same mix of red, green, and blue photoreceptive elements found in the Bayer pattern.

Moreover, by virtue of the fact that the hybrid sensor combines IR photoreceptive elements with visible-spectrum photoreceptive elements, an application can combine the IR information with the color information without the types of problems described above (associated with devices which use an IR sensor that is separate from the visible-spectrum sensor). This is because, in the hybrid sensor described herein, the visible-spectrum photoreceptive elements and the IR photoreceptive elements have the same lens focal length and camera perspective, and are subject to the same distortion.

The above technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows one implementation of a hybrid sensor.

FIG. 2 shows one implementation of a camera system that uses the hybrid sensor of FIG. 1.

FIGS. 3-6 show three respective applications of the hybrid sensor of FIG. 1.

FIGS. 7-9 show three patterns that can be embodied by the hybrid sensor of FIG. 1.

FIG. 10 shows a process for collecting infrared information and color information from the hybrid sensor of FIG. 1.

FIG. 11 shows a process that utilizes the infrared information and color information produced by the hybrid sensor of FIG. 1 within one or more end-use applications.

FIG. 12 shows illustrative computing functionality that can be used to implement an application that relies on the infrared information and the color information produced by the hybrid sensor of FIG. 1.

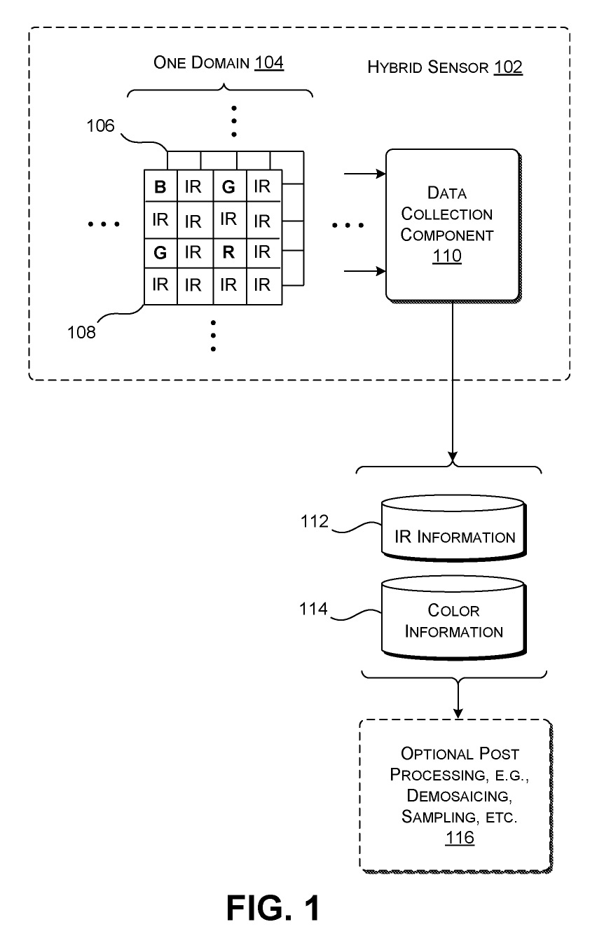

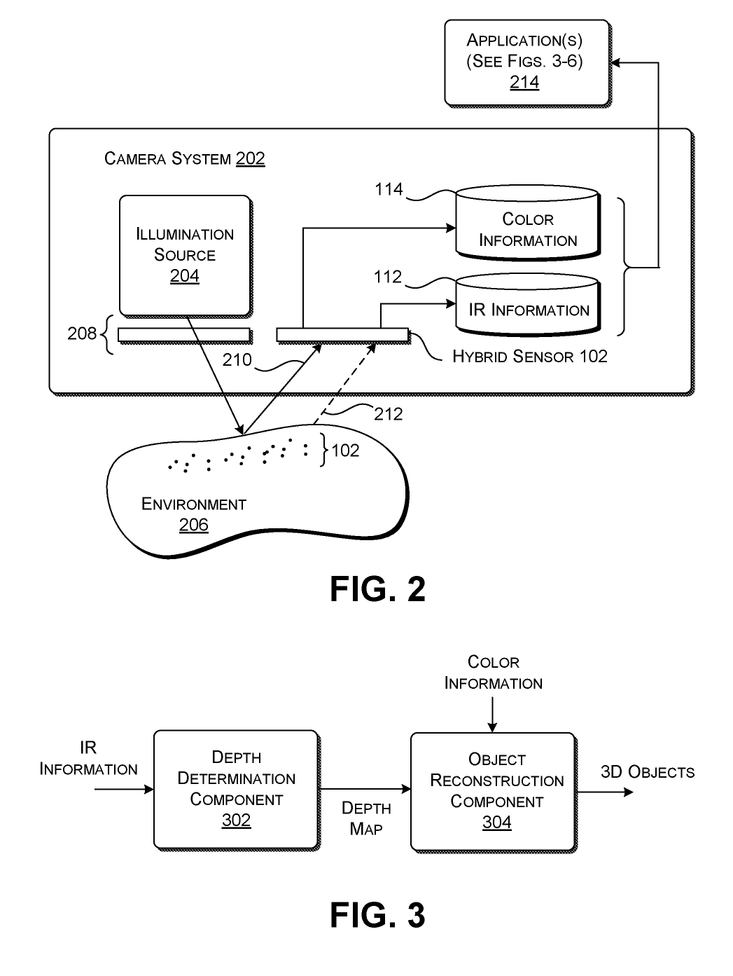

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a hybrid sensor and various applications thereof. Section B sets forth illustrative methods which explain the operation and application of the hybrid sensor of Section A. And Section C describes illustrative computing functionality that can be used to implement any application of the hybrid sensor.

As a preliminary matter, some of the figures describe concepts in the context of one or more structural components, also referred to as functionality, modules, features, elements, etc. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks).

As to terminology, the phrase “configured to” encompasses various physical and tangible mechanisms for performing an identified operation. The mechanisms can be configured to perform an operation using, for instance, software running on computer equipment, or other logic hardware (e.g., FPGAs), etc., or any combination thereof.

The term “logic” encompasses various physical and tangible mechanisms for performing a task. For instance, each operation illustrated in the flowcharts corresponds to a logic component for performing that operation. An operation can be performed using, for instance, software running on computer equipment, or other logic hardware (e.g., FPGAs), etc., or any combination thereof. When implemented by computing equipment, a logic component represents an electrical component that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific terms “computer-readable storage medium” and “computer-readable storage medium device” expressly exclude propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative System

FIG. 1 shows an illustrative hybrid sensor 102. The hybrid sensor includes a plurality of domains. FIG. 1 shows only a single representative domain 104. Each domain, in turn, includes a plurality of photoreceptive elements, each bearing a label (“R,”, “G,”, “B,” or “IR”). Each photoreceptive element is receptive to a particular portion of the spectrum of electromagnetic radiation.

More specifically, the domain 104 includes a first subset of infrared (IR) photoreceptive elements that are receptive to the infrared portion of the spectrum (e.g., 700-1000 nm), and a second subset of visible-spectrum photoreceptive elements that are receptive to visible portion of the spectrum (e.g., 400-700 nm). The second subset of visible-spectrum photoreceptive elements, in turn, can include plural groups of photoreceptive elements that are receptive to different portions of the visible spectrum. For instance, in the illustrative case of FIG. 1, the domain includes one photoreceptive element that is responsive to the red portion of the visible spectrum (e.g., 635-700 nm), two photoreceptive elements that are responsive to the green portion of the visible spectrum (e.g., 520-560 nm), and one photoreceptive element that is response to the blue portion of the visible spectrum (e.g., 450-490 nm). These ranges are illustrative; other implementations can modify any of these ranges, to thereby narrow a range, broaden a range, and/or shift a range.

In one implementation, the hybrid sensor 102 corresponds to a complementary metal-oxide-semiconductor (CMOS) sensor, provided as an integrated circuit chip. In one implementation, the hybrid sensor 102 can include a sensor array 106 of sensor elements made of silicon material (and/or some other semiconductor material). The sensor elements are sensitive to the intensity of light that impinges upon them, producing grayscale output results. The hybrid sensor 102 includes a color filter array 108 which overlays the sensor array. Different cells of the color filter array 108 have receptivity to different portions of the electromagnetic spectrum, thereby operating as bandpass filters. A photoreceptive element that is receptive to a particular portion of the electromagnetic spectrum may correspond to a filter array cell in conjunction with a sensor element. The use of the color filter array 108, in conjunction with the sensor array 106, enables filtering in both in the visible and IR realms, providing rich contextual information for depth sensing, semantic labeling, object recognition, and other computer vision applications.

In one case, the sensor array 106 and the color filter array 108 can be produced in a single semiconductor manufacturing process. In a second case, the sensor array 106 and the color filter array 108 can be produced in separate processes, and the color filter array 108 can then be combined with the sensor array 106. A color filter array can be conventionally produced using appropriate dyes or pigments.

A data collection component 110 collects infrared (IR) information from the IR photoreceptive elements, and collects color information from the visible-spectrum photoreceptive elements. In one case, the hybrid sensor 102 incorporates the data collection component 110 as a part thereof. For instance, in one implementation, the hybrid sensor 102 can correspond to an integrated circuit that includes a data collection component 110 in the form of reading circuitry. The reading circuitry can accept a column and row address and, in response, reads data from a specific photoreceptive element associated with the specified column and row. A first data store 112 may store the IR information, while a second data store 114 may store the color information.

According to one aspect of the hybrid sensor 102, the number of IR photoreceptive elements in a domain (and in the hybrid sensor 102 overall) is equal to or greater than the number of visible-spectrum photoreceptive elements. In other words, at least 50% of the photoreceptive elements of the hybrid sensor 102 are IR photoreceptive elements. In other implementations, the percentage of IR photoreceptive elements is at least 75%, or at least 80%, or at least 90%, etc. For the particular configuration shown in FIG. 1, 75% of the photoreceptive elements of the hybrid sensor 102 are IR photoreceptive elements. By virtue of this configuration, the IR information captures an imaged scene with a higher resolution compared to the color information

In any case, the hybrid sensor includes significantly more IR photoreceptive elements compared to other designs. For example, consider a hybrid sensor that modifies a conventional Bayer pattern by replacing one of the green photoreceptive elements with an IR photoreceptive element. This type of hybrid sensor allocates just 25% of a domain to collecting infrared radiation.

According to another illustrative aspect, each domain includes a mix of visible-spectrum photoreceptive elements that conforms to a Bayer pattern, or to some other color filter array pattern. With respect to the Bayer pattern, for instance, each domain includes an RGB mix that includes one red photoreceptive element, two green photoreceptive elements, one blue photoreceptive element, or some multiple of that RGB mix. Further, each domain conforms to the Bayer pattern insofar as it preserves the relationship among photoreceptive elements having different colors, as specified in the Bayer pattern. For example, the domain 104 shown in FIG. 1 includes a first diagonal relationship of two green photoreceptive elements, and a second diagonal relationship of a blue photoreceptive element and a red photoreceptive element. In other words, the domain 104 differs from the arrangement of a conventional manifestation of the Bayer pattern by interposing rows and columns of IR photoreceptive elements between the visible-spectrum photoreceptive elements; but the domain otherwise preserves the relationship among red, green, and blue photoreceptive elements specified in a Bayer pattern.

In other implementations, the hybrid sensor can conform to other types of color filter arrays. Without limitation, illustrative color filter arrays that can be used include: (1) an RGBE filter pattern that includes an RGBE mix of one red photoreceptive element, one green photoreceptive element, one blue photoreceptive element, and one emerald photoreceptive element, or some multiple of that RGBE mix; (2) a CYYM filter pattern that includes a CYYM mix of one cyan photoreceptive elements, two yellow photoreceptive elements, and one magenta photoreceptive element, or some multiple of that CYYM mix; (3) a CYGM filter pattern that includes a CYGM mix of one cyan photoreceptive element, one yellow photoreceptive element, one green photoreceptive element, and one magenta photoreceptive element, or some mix of that CYGM mix; (4) an RGBW filter pattern that includes an RGBW mix of one red photoreceptive element, one green photoreceptive element, one blue photoreceptive element, and one white photoreceptive element, or some mix of that RGBW mix, and so on.

In other cases, the hybrid sensor includes a first subset of IR photoreceptive elements and a second subset of monochrome (e.g., gray-scale-detecting) visible-spectrum photoreceptive elements.

The use of a relatively large number of IR photoreceptive elements has various advantages. Generally, any device or application that relies on active and/or passive IR imaging and/or multi-spectrum imaging can produce higher quality images due to the large number of IR photoreceptive elements provided by the hybrid sensor 102. For instance, consider an application (described more fully below) that relies on the IR information to produce a depth map (e.g., through a structured light technique, time-of-flight technique, stereo vision technique, etc.), and then uses the depth map to reconstruct the shapes of objects in a scene. That application can produce a high-resolution depth map by virtue of the fact that so many IR photoreceptive elements are allocated to detecting infrared radiation.

Second, the hybrid sensor 102 is capable of detecting infrared radiation that forms relatively small dots, lines, or other shapes on the surface of the hybrid sensor 102. This is because there is an increased chance that these small shapes will overlap with one or more IR photoreceptive elements. As a related advantage, a camera system that uses the hybrid sensor 102 can efficiently collect IR photons, again due to the increased probability that IR light will impinge on an IR photoreceptive element. For instance, this characteristic can enable the use of a reduced-power IR illumination source. Any application or device can also use various processing components to further control its levels of detection sensitivity and resolution (and the tradeoff between these two measures), such as pixel binning, filtering, de-noising, etc.

The use of a sensor array that conforms to a Bayer pattern or some other pattern has additional technical advantages. For example, the hybrid sensor 102 shown in FIG. 1 can produce balanced color image information. This is because each domain does not substitute visible-spectrum photoreceptive elements with IR photoreceptive elements (e.g., by substituting green photoreceptive elements with IR photoreceptive elements), but rather, “pulls” a complete color filter array apart and adds IR photoreceptive elements in between the visible-spectrum photoreceptive elements. It is particularly useful to avoid weakening the contribution of green photoreceptive elements, because the human eye is most receptive to the green portion of the visible spectrum.

Further, the use of a single hybrid sensor eliminates various problems that may occur due the use of a separate infrared sensor and a visible-spectrum sensor. These problems include, but are not limited to, artifacts caused by occlusions (in which one sensor detects a feature and the other does not), differences in perspective between the sensors, mechanical misalignment between the sensors, etc. The single hybrid sensor 102 eliminates or reduces these problems because it produces color information that is precisely linked to the infrared information, e.g., because all the information is captured at the same time by a single sensor having the same focal length and camera perspective. This design also eliminates the need for complex and costly calibration and synchronization of two image sensors to address the above-noted problems. Further, the use of a single sensor can be potentially more cheaply produced and efficiently powered compared to a design that uses two or more sensors.

Note, however, that while a camera system can employ a single hybrid sensor of the type described above, other implementations can employ two or more of the hybrid sensors of the type shown in FIG. 1.

FIG. 1 also shows optional post-processing components 116. These components 116 process the IR information and/or the color information. In one implementation, some or all of the post-processing components 116 are integrated into the hybrid sensor 102 itself, e.g., as part of the integrated circuit which implements the hybrid sensor 102. Alternatively, or in addition, at least some of the post-processing components 116 can be implemented by processing circuitry that is separate from the hybrid sensor 102.

The post-processing components 116 can include a conventional demosaicing component for reconstructing the color of a single pixel based on the values extracted from neighboring color photoreceptive elements. The post-processing components 116 can also include any type of sampling components. One such sampling component can up-sample the color information to the same resolution as the IR information, e.g., using texture information extracted from the IR information as a guide.

FIG. 2 shows an illustrative camera system 202 that can make use of the hybrid sensor 102 described above. In one illustrative (but non-limiting) case, the camera system 202 includes an illumination source 204 which irradiates an environment with infrared radiation. In one case, the illumination source 204 corresponds to a laser or a light emitting diode (LED) illumination source.

In a structured light technique, a diffraction grating 208 produces a pattern of infrared light. For instance, the illumination source 204 in conjunction with the diffraction grating 208 can produce a speckle pattern of infrared light. The speckle pattern may include a random arrangement of dots, optionally having different dot sizes. The camera system 202 stores information which describes the original speckle pattern that is emitted, which constitutes an undistorted source pattern. The speckle pattern impinges on different objects in the environment 206 and is distorted by the shapes of these objects, thereby producing a distorted reflected pattern, which is the counterpart of the undistorted source pattern.

The hybrid sensor 102 captures the infrared radiation 210 that is reflected from the objects in the scene, corresponding to the distorted reflected pattern. The hybrid sensor 102 may also receive ambient infrared radiation that is not attributed to the illumination source 204. The hybrid sensor 102 also captures the visible-spectrum light 212 that is reflected from the objects in the scene. The data collection component 110 (not specifically shown in FIG. 2) collects IR information from the IR photoreceptive elements, and collects color information from the visible-spectrum photoreceptive elements. The first data store 112 stores the IR information, while the second data store 114 stores the color information.

Another implementation of the camera system 202 employs a time-of-flight technique. Here, the illumination source can correspond to an infrared laser that emits a pulse of infrared light, or a series of pulses of infrared light. A diffuser can spread the infrared light across the environment 206. The hybrid sensor 102 captures the infrared radiation 210 that is reflected from objects in the environment 206, together with visible light 212. For each IR photoreceptive element, the hybrid sensor 102 can include timing circuitry which measures the difference in time between when the infrared radiation was emitted, and when the infrared radiation was captured by the IR photoreceptive element. That difference in time (or, equivalently, a difference in phase) relates to the distance traveled by the infrared light, which, in turn, is related to the depth of a point in the environment 206 from which the infrared light has been reflected.

Another implementation uses a stereo vision technique. Here, two or more hybrid sensors capture IR information and color information that describes a scene from two or more respective vantage points. Stereo vision techniques can also reconstruct depth information based on image information collected by a single hybrid sensor, e.g., based on a sequence of images captured by the sensor at different respective times.

Finally, FIG. 2 broadly indicates that one or more applications 214 can make use of the IR information and color information collected by the camera system 202. FIGS. 3-6 show four illustrative applications.

Beginning with FIG. 3, a depth determination component 302 can generate a depth map which describes the depth of various points in the environment 206 based on the IR information. In a structured light technique, the depth determination component 302 can determine the depth of the points based on consideration of the undistorted source pattern and the distorted reflected pattern. Background information on one illustrative technique for inferring depth from a distorted speckle pattern is described in U.S. patent Ser. No. 11/724,068 to Shpunt, et al., filed on Mar. 13, 2007, and U.S. patent Ser. No. 12/552,176 to Freedman, et al., filed on Jun. 19, 2008. In a time-of-flight technique, the depth determination component 302 reconstructs the depth of the points based on time information collected by the hybrid sensor 102, in conjunction with the known speed of light. In a stereo vision technique, the depth determination component 302 reconstructs the depth of the points based on a consideration of the physical separation between two or more hybrid sensors, the disparity between the images captured by the sensors, and the focal length of the camera system 202.

An object reconstruction component 304 reconstructs the shapes of objects in the environment 206 based on the depth map. The object reconstruction component 304 can do so using machine-learned statistical models and/or segmentation algorithms to identify clusters of points that correspond to objects in a scene, and then linking those points together to describe the shapes of the objects, e.g., as a mesh of triangle vertices, voxel vertices, etc. The object reconstruction component 304 can then apply the color information as textures to the objects, in effect, by “pasting” the color information onto the identified shapes. Illustrative background information regarding the general topic of object reconstruction based on depth images can be found, for instance, in Keller, et al., “Real-time 3D Reconstruction in Dynamic Scenes using Point-based Fusion,” in Proceedings of the 2013 International Conference on 3D Vision, 2013, pp. 1-8, and Izadi, et al., “KinectFusion: Real-time 3D Reconstruction and Interaction Using a Moving Depth Camera,” in Proceedings of the 24th Annual ACM Symposium on User Interface Software and Technology, October 2011, pp. 559-568.

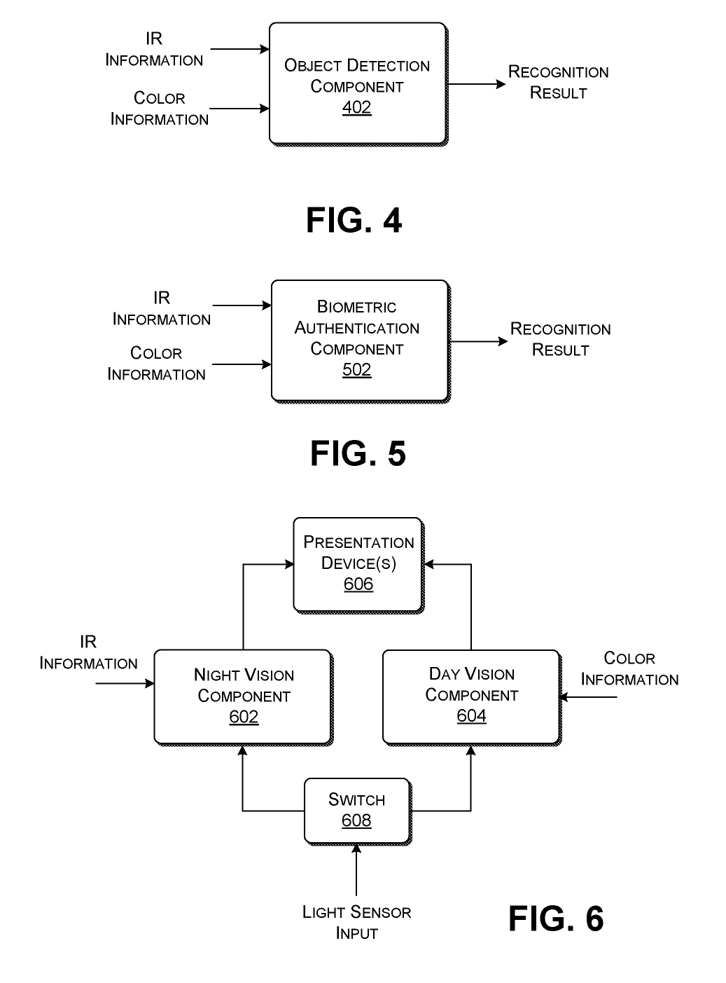

FIG. 4 shows another application that corresponds to an object detection component 402. The object detection component 402 maps information provided by the hybrid sensor 102 into an output conclusion, which represents a classification of at least some object or aspect of the environment 206. More specifically, the object detection component 402 can accept input in the form of the raw IR information and the raw color information provided by the hybrid sensor 102. Alternatively, or in addition, the object detection component 402 can accept higher-level features, such as information extracted from the depth map produced by the depth determination component 302 and/or the object reconstruction component 304 of FIG. 3. The object detection component 402 maps the above-described input information into an output conclusion. In one implementation, the object detection component 402 corresponds to a machine-learned statistical model. The statistical model can be implemented as a deep neural network, a decision tree model, a Bayesian network model, a clustering model, a support vector machine model, or any other kind of statistical model.

In another use scenario, the object detection component 402 can perform a semantic labeling operation. Here, the object detection component 402 can use the IR information and the color information to annotate an image with meaningful labels. In another case, a Simultaneous Localization and Mapping (SLAM) application can use the object detection component 402 to identify features in an environment, e.g., for the purpose of creating a feature-based map of the environment. The SLAM application then tracks the location of a mobile camera system within the environment based on the thus-created map.

FIG. 5 shows another application that corresponds to a biometric authentication component 502. The biometric authentication component 502 maps information provided by the hybrid sensor 102 into an indication that a person who presents himself or herself is a particular person X, or is not that particular person X. Like the object detection component 402, the biometric authentication component 502 can be implemented as machine-learned statistical model.

FIG. 6 shows another application that corresponds to a night vision apparatus. The night vision apparatus includes a night vision component 602 for generating a presentation based at least on the raw IR information (without necessarily constructing a depth map), and a day vision component 604 for generating a presentation based at least on the raw color information. A presentation device presents the output of the night vision component 602 and the day vision component 604. The presentation device 606, for instance, may correspond to a liquid crystal display device. A switch 608 can activate either the night vision component 602 or the day vision component 604 based on the amount of light in the environment 206 that is sensed by a light sensor. In another implementation, both the night vision component 602 and the day vision component 604 can contribute to the same presentation.

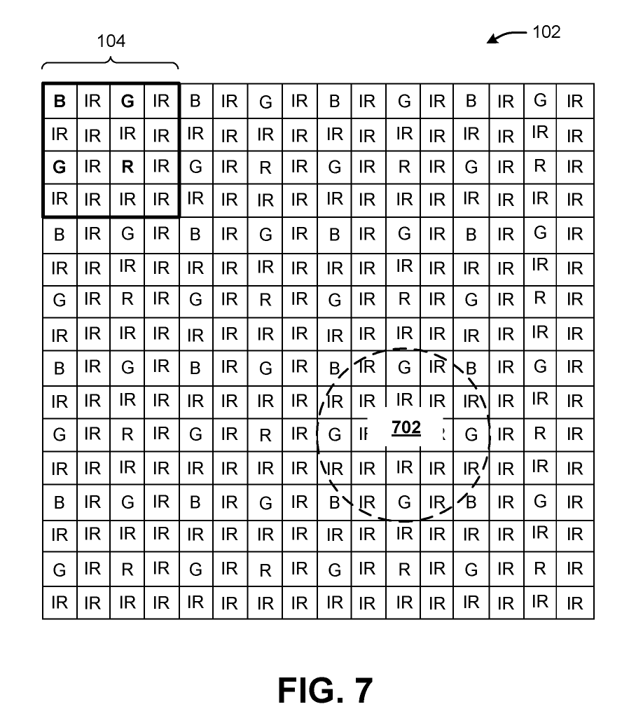

FIG. 7 shows a sample of a hybrid sensor 102 that has the same pattern described above with respect to FIG. 1. In other words, the hybrid sensor 102 shown in FIG. 7 duplicates the domain 104 across the surface of the hybrid sensor. Note, however, that the actual hybrid sensor 102 can include many more domains than is illustrated in FIG. 7.

As noted above, each domain conforms to the Bayer pattern, insofar as it has the same proportion of red, green, and blue photoreceptive-elements as a Bayer pattern, and because the arrangement of the red, green, and blue photoreceptive elements conforms to the Bayer pattern.

Also note that the hybrid sensor includes plural rows and columns of infrared photoreceptive elements. That is, each row or column forms a series of contiguous IR photoreceptive elements. The rows and columns of IR photoreceptive elements are interleaved with visible-spectrum photoreceptive elements. Overall, 75% of the photoreceptive elements in the hybrid sensor 102 are IR photoreceptive elements.

FIG. 7 also shows a dot 702 of infrared radiation that impinges the surface of the hybrid sensor 102. Note that the dot 702 activates more than a dozen IR photoreceptive elements. The infrared information collected by the photoreceptive elements allows an application to accurately detect the dot 702. Indeed, the hybrid sensor 102 can detect even smaller dots.

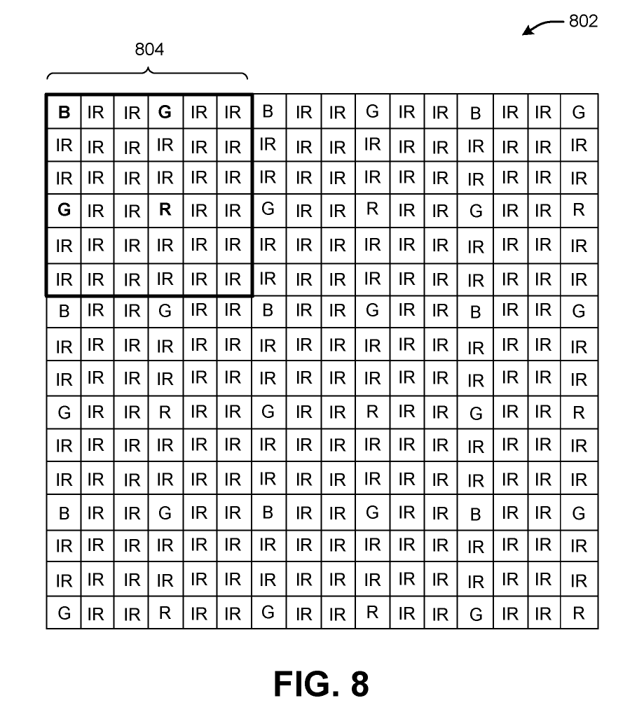

FIG. 8 shows another hybrid sensor 802 that has a representative domain 804. Like the case of FIG. 7, the domain 804 conforms to the Bayer pattern because it includes one red photoreceptive element, two green photoreceptive elements, and one blue photoreceptive elements. Further, the arrangement of these color photoreceptive elements conforms to the Bayer pattern. FIG. 8 differs from the hybrid sensor 102 of FIG. 7 because it includes additional IR photoreceptive elements. That is, FIG. 8 includes a design where pairs of adjacent rows of IR photoreceptive elements and pairs of adjacent columns of IR photoreceptive elements are interleaved amongst the visible-spectrum photoreceptive elements. Altogether, approximately 89% of the photoreceptive elements in the hybrid sensor 802 are IR photoreceptive elements.

More generally, a hybrid sensor can include groups of rows of IR photosensitive elements and groups of columns of IR photosensitive elements, where each group has n contiguous lines (rows or columns), where n=1, 2, 3, etc. The groups of IR photosensitive elements are interleaved amongst the visible-spectrum photosensitive elements. Increases in n yield progressively higher ratios of IR photosensitive elements to visible-spectrum photosensitive elements.

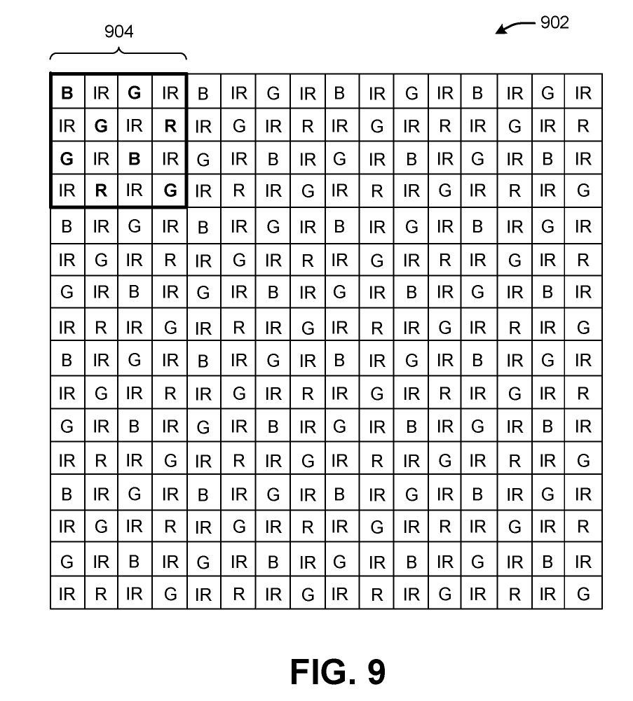

FIG. 9 shows another hybrid sensor that has a representative domain 904. This design conforms to the Bayer pattern insofar as each domain includes the same portion of red, green, and blue photoreceptive elements as a Bayer pattern. More specifically, the representative domain 904 includes two red photoreceptive elements, four green photoreceptive elements, and two blue photoreceptive elements, which is a multiple of two of the mixture of color photoreceptive elements found in a classic Bayer pattern. Other designs can embody other multiples of the mixture of elements found in a classic Bayer pattern. Overall, 50% of the photoreceptive elements in the hybrid sensor 902 of FIG. 9 are IR photoreceptive elements.

In the above examples, the hybrid sensors include photosensitive elements having the same physical sizes. But in other implementations, a hybrid sensor can include photosensitive elements of different sizes. For example, a hybrid sensor can include visible-spectrum photosensitive elements having a first physical size, and IR photosensitive elements having a second size, where the first size differs from the first size. Alternatively, or in addition, a hybrid sensor can include photosensitive elements of the same kind having different physical sizes, such as by including IR photosensitive elements of different sizes. Alternatively, or in addition, a hybrid sensor can create the equivalent of different-sized photosensitive elements through post-processing operations (e.g., via analog binning, digital binning, etc.). In the last-mentioned case, a hybrid sensor can also adjust the “sizes” of photosensitive elements in a dynamic manner.

Finally, the above examples emphasized cases in which the hybrid sensor includes at least 50% IR photosensitive elements. But other implementations of the hybrid sensor can include a ratio of IR photosensitive elements less than 50% but greater than 25%.

B. Illustrative Processes

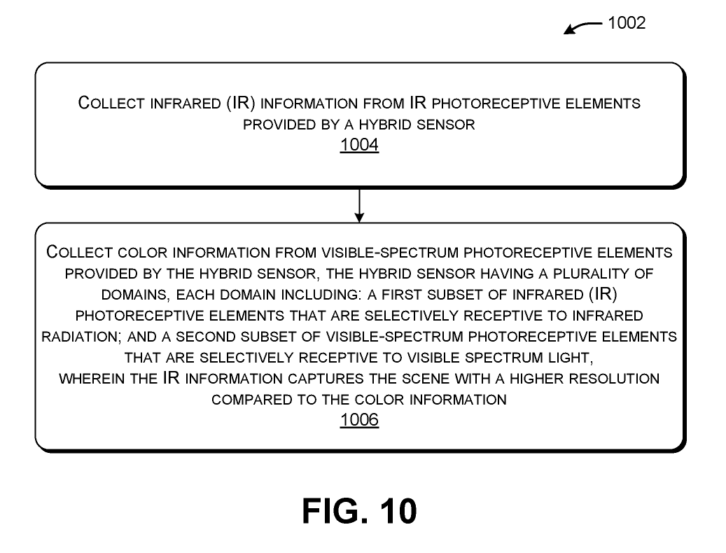

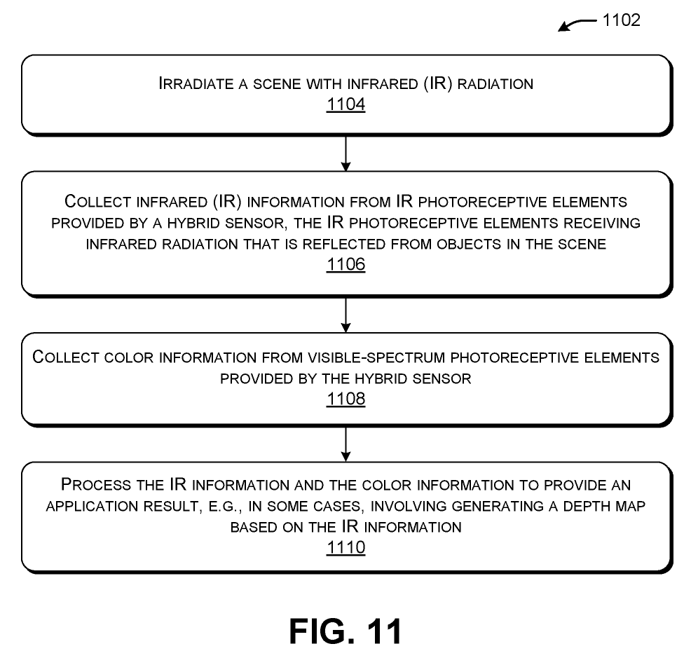

FIGS. 10 and 11 show processes (1002, 1102) that explain the operation of the hybrid sensor 102 and applications thereof in flowchart form. Since the principles underlying the operation of the hybrid sensor 102 (and applications thereof) have already been described in Section A, certain operations will be addressed in summary fashion in this section. As noted in the prefatory part of the Detailed Description, each flowchart is expressed as a series of operations performed in a particular order. But the order of these operations is merely representative, and can be varied in any manner.

FIG. 10 shows a process 1002 that describes one manner of collecting data from the hybrid sensor 102 of FIG. 1. In block 1004, the process 1002 entails collecting infrared (IR) information from IR photoreceptive elements provided by the hybrid sensor 102. In block 1006, the process entails collecting color information from visible-spectrum photoreceptive elements provided by the hybrid sensor 102. The hybrid sensor 102 has a plurality of domains, each domain including: a first subset of infrared (IR) photoreceptive elements that are selectively receptive to infrared radiation; and a second subset of visible-spectrum photoreceptive elements that are selectively receptive to visible spectrum light. The IR information captures the scene with a higher resolution compared to the color information.

FIG. 11 shows a process 1102 for applying the data collected from the hybrid sensor 102 of FIG. 1. In block 1104, the camera system 202 (of FIG. 2) irradiates the environment 206 with infrared radiation. In block 1106, the camera system 202 collects IR information from the IR photoreceptive elements of the hybrid sensor 102, in response to infrared radiation being reflected from objects in the environment 206. In block 1108, the camera system 202 collects color information from the visible-spectrum photoreceptive elements provided by the hybrid sensor 102. In block 1110, an application processes the IR information and the color information to provide an application result, e.g., by generating a depth map based on the IR information and then reconstructing the shapes of objects in the scene based on the depth map, etc.

C. Representative Computing Functionality

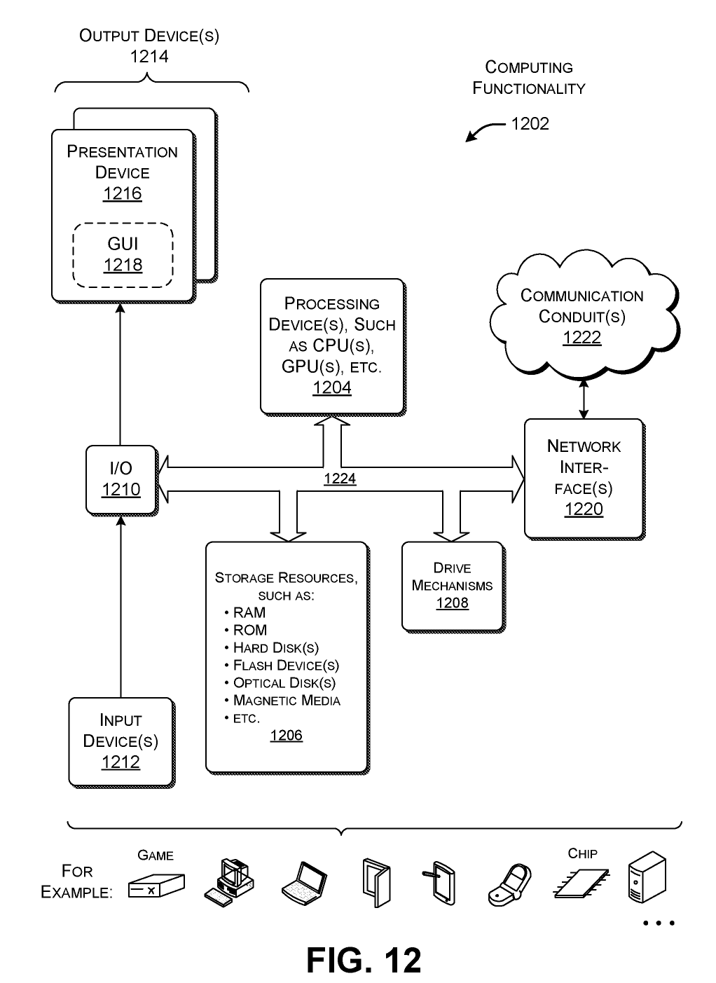

FIG. 12 shows computing functionality 1202 that can be used to implement any aspect of the applications set forth in FIGS. 3-6, such as computing a depth map, reconstructing objects, recognizing objects, authenticating users, and so on. In all cases, the computing functionality 1202 represents one or more physical and tangible processing mechanisms.

The computing functionality 1202 can include one or more hardware processor devices 1204, such as one or more central processing units (CPUs), and/or one or more graphical processing units (GPUs), and so on. The computing functionality 1202 can also include any storage resources (also referred to as computer-readable storage media or computer-readable storage medium devices) 1206 for storing any kind of information, such as machine-readable instructions, settings, data, etc. Without limitation, for instance, the storage resources 1206 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 1202. The computing functionality 1202 may perform any of the functions described above when the hardware processor device(s) 1204 carry out computer-readable instructions stored in any storage resource or combination of storage resources. For instance, the computing functionality 1202 may carry out computer-readable instructions to perform the computation of a depth map, the reconstruction of objects in a scene, the recognition of an object, etc. The computing functionality 1202 also includes one or more drive mechanisms 1208 for interacting with any storage resource, such as a hard disk drive mechanism, an optical disk drive mechanism, and so on.

The computing functionality 1202 also includes an input/output component 1210 for receiving various inputs (via input devices 1212), and for providing various outputs (via output devices 1214). One illustrative input device corresponds to the hybrid sensor 102 of FIG. 1. One particular output mechanism may include a display device 1216 and an associated graphical user interface presentation (GUI) 1218. The display device 1216 may correspond to a charge-coupled display device, a cathode ray tube device, a projection mechanism, etc. Other output devices include a printer, one or more speakers, a haptic output mechanism, an archival mechanism (for storing output information), and so on. The computing functionality 1202 can also include one or more network interfaces 1220 for exchanging data with other devices via one or more communication conduits 1222. One or more communication buses 1224 communicatively couple the above-described components together.

The communication conduit(s) 1222 can be implemented in any manner, e.g., by a local area computer network, a wide area computer network (e.g., the Internet), point-to-point connections, etc., or any combination thereof. The communication conduit(s) 1222 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 1202 (and its hardware processor) can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc. In this case, the machine-executable instructions are embodied in the hardware logic itself.

The following summary provides a non-exhaustive list of illustrative aspects of the technology set forth herein.

According to a first aspect, a hybrid sensor is described that has a plurality of domains that include photoreceptive elements. Each domain includes: a first subset of infrared (IR) photoreceptive elements that are selectively receptive to infrared radiation between 700 and 1000 nm; and a second subset of visible-spectrum photoreceptive elements that are selectively receptive to visible spectrum light. A number of IR photoreceptive elements in the first subset is equal to or greater than a number of visible-spectrum photoreceptive elements in the second subset.

According to a second aspect, the second subset of visible-spectrum elements includes at least: a first group of photoreceptive elements that are receptive to a first color of light; a second group of photoreceptive elements that are receptive to a second color of light; and a third group of photoreceptive elements that are receptive to a third color of light.

According to a third aspect, in the hybrid sensor according to the above-mentioned second aspect, the first color of light is green, the second color of light is red, and the third color of light is blue.

According to a fourth aspect, the photoreceptive elements in the second subset are arranged to have a same proportion of color photoreceptive elements as specified in a Bayer pattern, such that the second subset includes an RGB mix of one red photoreceptive element, two green photoreceptive elements, and one blue photoreceptive element, or some multiple of that RGB mix.

According to a fifth aspect, in the hybrid sensor according to the fourth aspect, the photoreceptive elements in the second subset are also configured such that the red photoreceptive element, the green photoreceptive elements, and the blue photoreceptive element are arranged with respect to each other in conformance with the Bayer pattern.

According to a sixth aspect, the photoreceptive elements in the second subset are arranged to have a same proportion of photoreceptive elements as specified in one of: an RGB (Bayer) pattern that includes an RGB mix of one red photoreceptive element, two green photoreceptive elements, and one blue photoreceptive element, or some multiple of that RGB mix; an RGBE filter pattern that includes an RGBE mix of one red photoreceptive element, one green photoreceptive element, one blue photoreceptive element, and one emerald photoreceptive element, or some multiple of that RGBE mix; or a CYYM filter pattern that includes a CYYM mix of one cyan photoreceptive elements two yellow photoreceptive elements, and one magenta photoreceptive element, or some multiple of that CYYM mix; or a CYGM filter pattern that includes a CYGM mix of one cyan photoreceptive element, one yellow photoreceptive element, one green photoreceptive element, and one magenta photoreceptive element, or some mix of that CYGM mix; or an RGBW filter pattern that includes an RGBW mix of one red photoreceptive element, one green photoreceptive element, one blue photoreceptive element, and one white photoreceptive element, or some mix of that RGBW mix.

According to a seventh aspect, the second subset of visible-spectrum photoreceptive elements includes a collection of monochrome photoreceptive elements.

According to an eighth aspect, the IR photoreceptive elements across the domains form a plurality of lines of IR photoreceptive elements, interspersed amongst visible-spectrum photoreceptive elements, wherein each line of IR photoreceptive elements forms a contiguous series of IR photoreceptive elements.

According to a ninth aspect, in the hybrid sensor according to the eighth aspect, the hybrid sensor includes a plurality of horizontal and/or vertical and/or diagonal lines of IR photoreceptive elements.

According to a tenth aspect, in the hybrid sensor according to the eighth aspect, each line of IR photoreceptive elements has at least one neighboring line of IR photoreceptive elements that is contiguous thereto.

According to an eleventh aspect, at least 75% of the photoreceptive elements in the hybrid sensor are IR photoreceptive elements.

According a twelfth aspect, at least 80% of the photoreceptive elements in the hybrid sensor are IR photoreceptive elements.

According to a thirteenth aspect, a device is described herein for capturing images of an environment. The device provides a hybrid sensor that includes a plurality of domains that include photoreceptive elements. Each domain, in turn, includes: a first subset of infrared (IR) photoreceptive elements that are selectively receptive to infrared radiation; and a second subset of visible-spectrum photoreceptive elements that are selectively receptive to visible spectrum light. A number of IR photoreceptive elements in the first subset is equal to or greater than a number of visible-spectrum photoreceptive elements in the second subset. The device further includes a data collection component that is configured to collect IR information from the IR photoreceptive elements and color information from the visible-spectrum photoreceptive elements. The device also includes an application configured to processes the IR information and the color information to provide at least one application end result.

According to a fourteenth aspect, the device further includes at least one infrared source for irradiating a scene with infrared radiation. The IR photoreceptive elements detect infrared radiation produced by the infrared source and reflected from objects in the scene. The application includes a depth determination component that produces a depth map of the scene based on the IR information.

According to a fifteenth aspect, the depth determination component uses one or more of a stereo vision, and/or structured light, and/or a time-of-flight technique to produce the depth map, based on the IR information.

According to a sixteenth aspect, a method is described for collecting information from a scene. The method includes: collecting infrared (IR) information from IR photoreceptive elements provided by a hybrid sensor; and collecting color information from visible-spectrum photoreceptive elements provided by the hybrid sensor. The hybrid sensor has a plurality of domains, each domain including: a first subset of infrared (IR) photoreceptive elements that are selectively receptive to infrared radiation; and a second subset of visible-spectrum photoreceptive elements that are selectively receptive to visible spectrum light. The IR information captures the scene with a same or higher resolution compared to the color information.

According to a seventeenth aspect, in the method of the sixteenth aspect, the photoreceptive elements in the second subset are arranged to have a same proportion of color photoreceptive elements as specified in a Bayer pattern, such that the second subset includes an RGB mix of one red photoreceptive element, two green photoreceptive elements, and one blue photoreceptive element, or some multiple of that RGB mix.

According to an eighteenth aspect, in the method of the seventeenth aspect, the photoreceptive elements in the second subset are further configured such that the red photoreceptive element, the green photoreceptive elements, and the blue photoreceptive element are arranged with respect to each other in conformance with the Bayer pattern.

According to a nineteenth aspect, in the method according to the sixteenth aspect, at least 75% of the photoreceptive elements in the hybrid sensor are IR photoreceptive elements.

According to twentieth aspect, in the method of sixteenth aspect, at least 80% of the photoreceptive elements in the hybrid sensor are IR photoreceptive elements.

A twenty-first aspect corresponds to any combination (e.g., any permutation or subset that is not logically inconsistent) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A hybrid sensor, comprising:
a plurality of domains that include photoreceptive elements,
each domain including:
a first subset of infrared (IR) photoreceptive elements that are selectively receptive to infrared radiation between 700 and 1000 nm; and
a second subset of visible-spectrum photoreceptive elements that are selectively receptive to visible spectrum light,
a number of IR photoreceptive elements in the first subset being equal to or greater than a number of visible-spectrum photoreceptive elements in the second subset.

2. The hybrid sensor of claim 1, wherein the second subset of visible-spectrum elements includes at least:
a first group of photoreceptive elements that are receptive to a first color of light;
a second group of photoreceptive elements that are receptive to a second color of light; and
a third group of photoreceptive elements that are receptive to a third color of light.

3. The hybrid sensor of claim 2, wherein the first color of light is green, the second color of light is red, and the third color of light is blue.

4. The hybrid sensor of claim 1, wherein the photoreceptive elements in the second subset are arranged to have a same proportion of color photoreceptive elements as specified in a Bayer pattern, such that the second subset includes an RGB mix of one red photoreceptive element, two green photoreceptive elements, and one blue photoreceptive element, or some multiple of that RGB mix.

5. The hybrid sensor of claim 4, wherein the photoreceptive elements in the second subset are further configured such that the red photoreceptive element, the green photoreceptive elements, and the blue photoreceptive element are arranged with respect to each other in conformance with the Bayer pattern.

6. The hybrid sensor of claim 1, wherein the photoreceptive elements in the second subset are arranged to have the same proportion of photoreceptive elements as specified in one of:
an RGB (Bayer) pattern that includes an RGB mix of one red photoreceptive element, two green photoreceptive elements, and one blue photoreceptive element, or some multiple of that RGB mix; or
an RGBE filter pattern that includes an RGBE mix of one red photoreceptive element, one green photoreceptive element, one blue photoreceptive element, and one emerald photoreceptive element, or some multiple of that RGBE mix; or
a CYYM filter pattern that includes a CYYM mix of one cyan photoreceptive elements two yellow photoreceptive elements, and one magenta photoreceptive element, or some multiple of that CYYM mix; or
a CYGM filter pattern that includes a CYGM mix of one cyan photoreceptive element, one yellow photoreceptive element, one green photoreceptive element, and one magenta photoreceptive element, or some mix of that CYGM mix; or
an RGBW filter pattern that includes an RGBW mix of one red photoreceptive element, one green photoreceptive element, one blue photoreceptive element, and one white photoreceptive element, or some mix of that RGBW mix.

7. The hybrid sensor of claim 1, wherein the second subset of visible-spectrum photoreceptive elements includes a collection of monochrome photoreceptive elements.

8. The hybrid sensor of claim 1,
wherein the IR photoreceptive elements across the domains form a plurality of lines of IR photoreceptive elements, interspersed amongst visible-spectrum photoreceptive elements,
wherein each line of IR photoreceptive elements forms a contiguous series of IR photoreceptive elements.

9. The hybrid sensor of claim 8, wherein the hybrid sensor includes a plurality of horizontal and/or vertical and/or diagonal lines of IR photoreceptive elements.

10. The hybrid sensor of claim 8, wherein each line of IR photoreceptive elements has at least one neighboring line of IR photoreceptive elements that is contiguous thereto.

11. The hybrid sensor of claim 1, where at least 75% of the photoreceptive elements in the hybrid sensor are IR photoreceptive elements.

12. The hybrid sensor of claim 1, wherein at least 80% of the photoreceptive elements in the hybrid sensor are IR photoreceptive elements.

13. A device for capturing images of an environment, comprising:
a hybrid sensor that includes:
a plurality of domains that include photoreceptive elements, each domain including:
a first subset of infrared (IR) photoreceptive elements that are selectively receptive to infrared radiation; and
a second subset of visible-spectrum photoreceptive elements that are selectively receptive to visible spectrum light,
a number of IR photoreceptive elements in the first subset being equal to or greater than a number of visible-spectrum photoreceptive elements in the second subset;
a data collection component that is configured to collect IR information from the IR photoreceptive elements and color information from the visible-spectrum photoreceptive elements; and
an application configured to processes the IR information and the color information to provide at least one application end result.

14. The device of claim 13,
further including at least one infrared source for irradiating a scene with infrared radiation,
wherein the IR photoreceptive elements detect infrared radiation produced by the infrared source and reflected from objects in the scene, and
wherein the application includes a depth determination component that produces a depth map of the scene based on the IR information.

15. The device of claim 14, wherein the depth determination component uses one or more of a stereo vision, and/or structured light, and/or a time-of-flight technique to produce the depth map, based on the IR information.

16. A method for collecting information from a scene comprising:
collecting infrared (IR) information from IR photoreceptive elements provided by a hybrid sensor; and
collecting color information from visible-spectrum photoreceptive elements provided by the hybrid sensor,
the hybrid sensor having a plurality of domains, each domain including:
a first subset of infrared (IR) photoreceptive elements that are selectively receptive to infrared radiation; and
a second subset of visible-spectrum photoreceptive elements that are selectively receptive to visible spectrum light,
wherein the IR information captures the scene with a same or higher resolution compared to the color information.

17. The method of claim 16, wherein the photoreceptive elements in the second subset are arranged to have a same proportion of color photoreceptive elements as specified in a Bayer pattern, such that the second subset includes an RGB mix of one red photoreceptive element, two green photoreceptive elements, and one blue photoreceptive element, or some multiple of that RGB mix.

18. The method of claim 17, wherein the photoreceptive elements in the second subset are further configured such that the red photoreceptive element, the green photoreceptive elements, and the blue photoreceptive element are arranged with respect to each other in conformance with the Bayer pattern.

19. The method of claim 16, where at least 75% of the photoreceptive elements in the hybrid sensor are IR photoreceptive elements.

20. The method of claim 16, wherein at least 80% of the photoreceptive elements in the hybrid sensor are IR photoreceptive elements.
